(19) United States
(12) Patent Application Publication
(10) Pub. No.: US 2019/0204907 A1
(43) Pub. Date: Jul. 4, 2019

(54) SYSTEM AND METHOD FOR HUMAN-MACHINE INTERACTION

(71) Applicants: SHANGHAI GUANG HUI ZHI FU INTELLECTUAL PROPERTY CONSULTING CO., LTD., Shanghai (CN); Iknowing INC., Shanghai (CN)

(72) Inventors: Dianxia XIE, Shanghai (CN); Li DING, Shanghai (CN); Yongmei SHI, Shanghai (CN); Yuwen YAN, Shanghai (CN)

(73) Assignees: SHANGHAI GUANG HUI ZHI FU INTELLECTUAL PROPERTY CO NSULTING CO., LTD., Shanghai (CN); Iknowing INC., Shanghai (CN)

(21) Appl. No.: 16/297,646

(22) Filed: Mar. 9, 2019

Related U.S. Application Data
(63) Continuation of application No. PCT/CN2016/098551, filed on Sep. 9, 2016.

(51) Int. Cl. G06F 3/01; G06F 3/16; G10L 15/22; G10L 15/18; G06F 17/27

(52) U.S. Cl. CPC G06F 3/011; G06F 3/167; G06F 17/278; G10L 15/1815; G10L 15/22

(57) ABSTRACT

The present disclosure relates to a method and system for human-machine interaction. The method may include receiving input information. The input information may include scene information and a user input from a user. The method may also include determining an avatar based on the scene information, and determining user intention information based on the user input. The method may include determining output information based on the user intention information. The output information may include interaction information between the avatar and a user. The method may further include presenting the avatar based on the output information.

### CROSS-REFERENCE TO RELATED APPLICATIONS

This application is a Continuation of International Application No. PCT/CN2016/098551, filed on Sep. 9, 2016, the entire contents of which are hereby incorporated by reference.

### TECHNICAL FIELD

The present disclosure relates to a human-machine interaction (HMI) technology, and in particular, to systems and methods for human-machine interaction (HMI).

### BACKGROUND

With the continuous development of holographic display technology, image generation technologies, e.g., holographic projection, virtual reality (VR) and augmented reality (AR), have more and more applications in the human-machine interaction (HMI) fields. A user may gain an HMI experience with holographically displayed image(s). The user may also realize information transmission between human and machine through a button, a touch screen, or the like.

### SUMMARY

In one aspect of the present disclosure, a method for human-machine interaction is provided. The method may include: receiving input information, wherein the input information includes scene information and a user input from a user; determining an avatar based on the scene information; determining user intention information based on the user input; and determining output information based on the user intention information, wherein the output information includes interaction information between the avatar and the user.

In another aspect of the present disclosure, a system for human-machine interaction is provided. The system may include a processor and a computer-readable storage medium. The processor may be configured to execute one or more executable modules stored in the computer-readable storage medium. The computer-readable storage medium may store a set of instructions. When executed by the processor, the set of instructions may cause the processor to perform operations including: receiving input information, wherein the input information includes scene information and a user input from a user; determining an avatar based on the scene information; determining user intention information based on the input information; and determining output information based on the user intention information, wherein the output information includes interaction information between the avatar and the user.

In yet another aspect of the present disclosure, a non-transitory computer-readable medium is provided. The non-transitory computer-readable medium may be configured to store information. When a computer reads the information, the computer may perform the method of human-machine interaction, including: receiving input information, wherein the input information includes scene information and a user input from a user; determining an avatar based on the scene information; determining user intention information based on the input information; and determining output information based on the user intention information, wherein the output information includes interaction information between the avatar and the user.

In some embodiments, the method may further include presenting the avatar based on the output information.

In some embodiments, the user input may include information provided by voice input.

In some embodiments, the determining user intention information based on the user input may include extracting entity information and sentence information included in the voice input, and determining the user intention information based on the entity information and the sentence information.

In some embodiments, the determining an avatar may include generating a visual presentation of the avatar by a holographic projection.

In some embodiments, the interaction information between the avatar and the user may include a motion and a verbal communication by the avatar.

In some embodiments, the motion of the avatar may include a lip movement of the avatar. The lip movement may match the verbal communication by the avatar.

In some embodiments, the output information may be determined based on the user intention information and specific information of the avatar.

In some embodiments, the specific information of the avatar may include at least one of identity information, creation information, voice information, experience information, or personality information of a specific character that the avatar represents.

In some embodiments, the scene information may include information regarding a geographic location of the user.

In some embodiments, the determining output information based on the user intention information may include at least one of: searching for information from a system database, invoking a third party service application, or process the intention information based on a big data analysis.

In some embodiments, the avatar may include a cartoon character, an anthropomorphic animal character, a real historical character, or a real contemporary character.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. The like reference numerals in each drawing represent similar structures throughout the several views of the drawings, and wherein:

FIGS. 1-A and 1-B are schematic diagrams illustrating exemplary human-machine interaction (HMI) systems according to some embodiments of the present disclosure;

FIG. 2 is a schematic diagram illustrating an exemplary computing device according to some embodiments of the present disclosure;

FIG. 3 is a schematic diagram illustrating a holographic image generation device according to some embodiments of the present disclosure;

FIG. 4 is a schematic diagram illustrating a holographic image generation device according to some embodiments of the present disclosure;

FIG. 5 is a schematic diagram illustrating an exemplary server according to some embodiments of the present disclosure;

FIG. 6 is a schematic diagram illustrating an exemplary database according to some embodiments of the present disclosure;

FIG. 7 is a schematic diagram illustrating exemplary application scenes of an HMI system according to some embodiments of the present disclosure;

FIG. 8 is a flowchart illustrating an exemplary process for implement a human-machine interaction according to some embodiments of the present disclosure;

FIG. 9 is a flowchart illustrating an exemplary process for semantic extraction according to some embodiments of the present disclosure; and

FIG. 10 is a flowchart illustrating an exemplary process for determining an output signal according to some embodiments of the present disclosure.

### DETAILED DESCRIPTION

In order to illustrate the technical solutions related to the embodiments of the present disclosure, a brief introduction of the drawings referred to in the description of the embodiments is provided below. Obviously, drawings described below are only some illustrations or embodiments of the present disclosure. A person of ordinary skill in the art, without further creative effort, may apply the present teachings to other scenes according to these drawings. Unless stated otherwise or obvious from the context, the same reference numeral in the drawings refers to the same structure and operation.

As used in the disclosure and the appended claims, the singular forms “a,” “an,” and “the” include plural referents unless the content clearly dictates otherwise. It will be further understood that the terms “include,” and/or “comprise,” when used in this disclosure, specify the presence of integers, devices, behaviors, stated features, steps, elements, operations, and/or components, but do not exclude the presence or addition of one or more other integers, devices, behaviors, features, steps, elements, operations, components, and/or groups thereof.

Some modules of the system may be referred to in various ways according to some embodiments of the present disclosure. However, any number of different modules may be used and operated in a client terminal and/or a server. These modules are intended to be illustrative, not intended to limit the scope of the present disclosure. Different modules may be used in different aspects of the system and method.

According to some embodiments of the present disclosure, flowcharts are used to illustrate the operations performed by the system. It is to be expressly understood, the operations above or below may or may not be implemented in order. Conversely, the operations may be performed in inverted order, or simultaneously. Besides, one or more other operations may be added to the flowcharts, or one or more operations may be omitted from the flowchart.

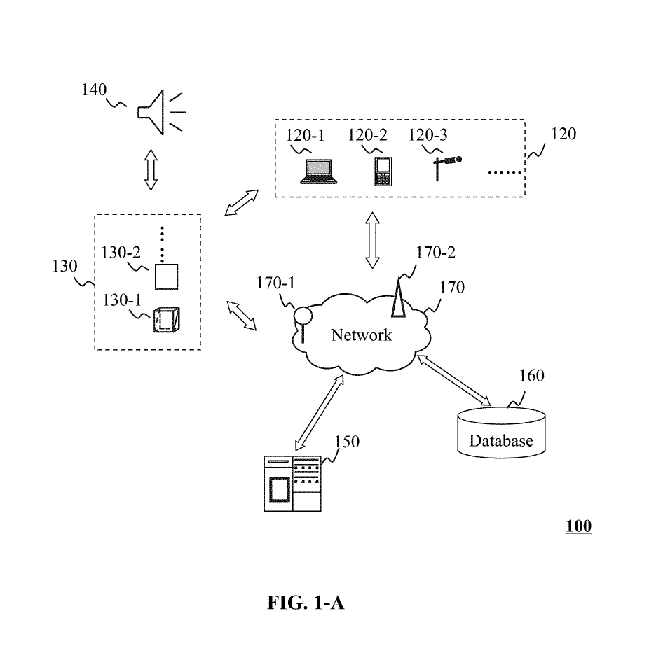

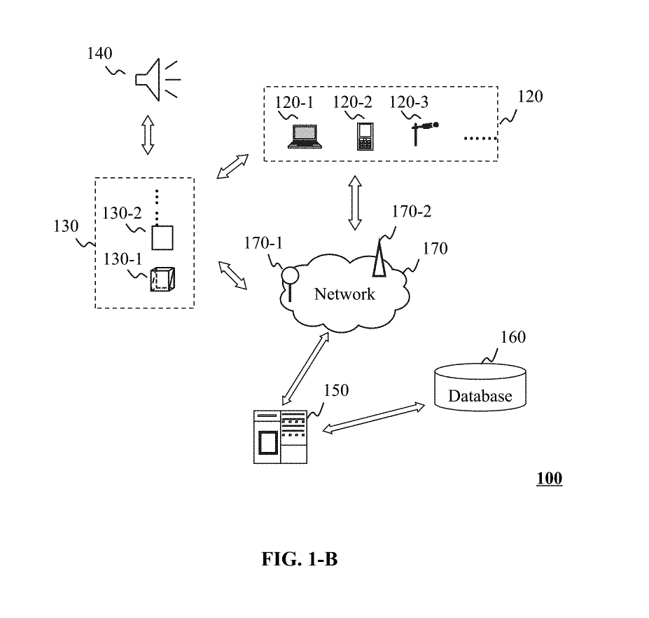

FIG. 1-A is a schematic diagram illustrating an exemplary human-machine interaction (HMI) system according to some embodiments of the present disclosure. A user may interact with the HMI system 100. The HMI system 100 may include an input device 120, an image output device 130, a content output device 140, a server 150, a database 160, and a network 170. For brevity, the HMI system 100 may also be referred to as the system 100 in the present disclosure.

The input device 120 may collect input information. In some embodiments, the input device 120 may be a speech signal collection device that is capable of collecting information provided by voice input from a user. The input device 120 may include a device that can convert a vibration signal into an electrical signal. For example, the input device 120 may be a microphone. In some embodiments, the input device 120 may obtain a speech signal by analyzing vibrations of other items caused by sound waves. For example, the input device 120 may obtain a voice signal by detecting and analyzing vibrations of water waves caused by sound waves. In some embodiments, the input device 120 may be a recorder 120-3. In some embodiments, the input device 120 may be any device that includes a microphone, such as a mobile computing device (e.g., a mobile phone 120-2, etc.), a computer 120-1, a tablet computer, a smart wearable device (including smart glasses such as Google Glasses, a smart watch, a smart ring, a smart helmet, etc.), a virtual reality device or an augmented reality device such as Oculus Rift, Gear VR, Hololens, or the like, or any combination thereof. In some embodiments, the input device 120 may include a text input device. For example, the input device 120 may be a text input device such as a keyboard, a tablet, or the like. In some embodiments, the input device 120 may include a non-text input device. For example, the input device 120 may include a selection input device such as a button, a mouse, or the like. In some embodiments, the input device 120 may include an image input device. In some embodiments, the input device 120 may include an image capturing device such as a camera, a video camera, or the like. In some embodiments, the input device 120 may implement face recognition. In some embodiments, the input device 120 may include a sensing device that is capable of detecting information related to an application scene. In some embodiments, the input device 120 may include a device that is capable of recognizing a motion or a location of a user. In some embodiments, the input device 120 may include a device for gesture recognition. In some embodiments, the input device 120 may include a sensor that is capable of detecting a status and/or a location of the user, such as an infrared sensor, a somatosensory sensor, a brain wave sensor, a speed sensor, an acceleration sensor, a positioning device (e.g., a global positioning system (GPS), a global navigation satellite system (GLONASS), a Beidou navigation system, a Galileo positioning system (Galileo), a quasi-zenith satellite system (QAZZ), a base station positioning system, a Wi-Fi positioning system, etc.), a pressure sensor, or the like, or any combination thereof. In some embodiments, the input device 120 may include a device that is capable of detecting ambient information. In some embodiments, the input device 120 may include a sensor such as a light sensor, a temperature sensor, a humidity sensor, etc. that is capable of detecting ambient states. In some embodiments, the input device 120 may be an independent hardware unit that can implement one or more of the above input manners. In some embodiments, one or more of the above input devices may be installed at different locations of the system 100, or be worn or carried by the user.

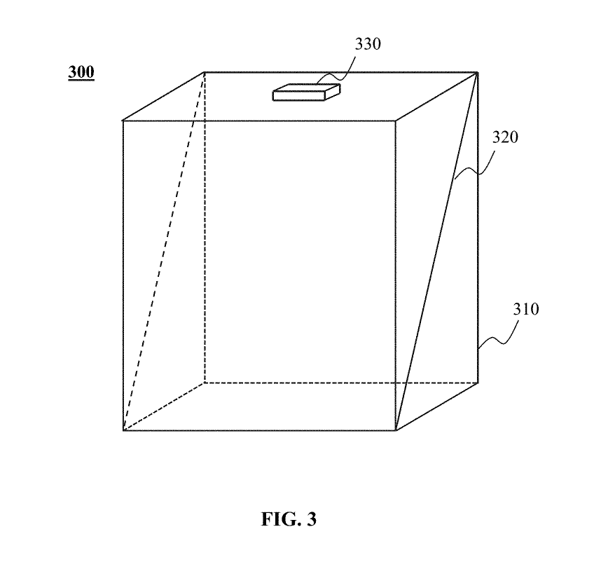

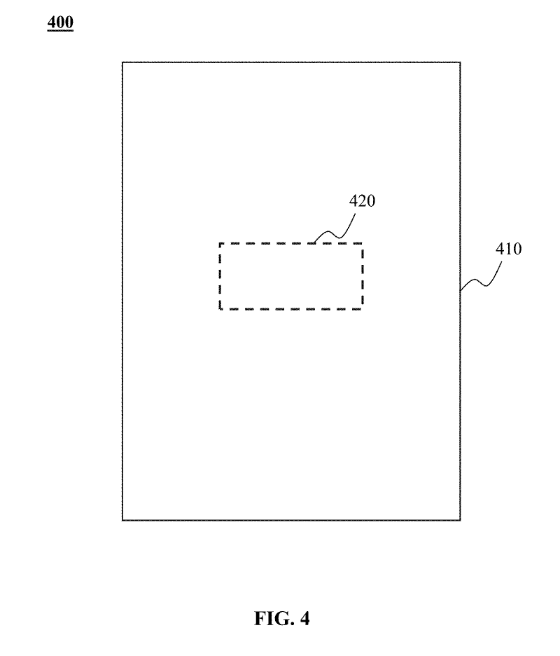

The image output device 130 may generate an image and/or display the image. The image may be a static or dynamic image that interacts with the user. In some embodiments, the image output device 130 may be an image display device. For example, the image output device 130 may be a standalone display screen or other devices that include a microphone, such as a projection device, a mobile phone, a computer, a tablet computer, a television, a smart wearable device (including smart glasses such as Google Glasses, a smart watch, a smart ring, a smart helmet, etc.), a virtual reality device, an augmented reality device, or the like, or any combination thereof. The system 100 may display an avatar via the image output device 130. In some embodiments, the image output device 130 may be a holographic image generation device. FIG. 3 and FIG. 4 are schematic diagrams illustrating a holographic image generation device according to some embodiments of the present disclosure. In some embodiments, the holographic image may be generated by reflection of a holographic film. In some embodiments, the holographic image may be generated by reflection of a water mist screen. In some embodiments, the image output device 130 may be a 3D image generation device, and the user may see a stereoscopic effect by wearing 3D glasses. In some embodiments, the image output device 130 may be a naked-eye 3D image generation device, and the user may see a stereoscopic effect without wearing 3D glasses. In some embodiments, the naked-eye 3D image generation device may be implemented by adding a slit grating in front of the screen. In some embodiments, the naked-eye 3D image generation device may include a micro-column lens. In some embodiments, the image output device 130 may be a virtual reality generation device. In some embodiments, the image output device 130 may be an augmented reality generation device. In some embodiments, the image output device 130 may be a mixed reality device.

In some embodiments, the image output device 130 may output a control signal. In some embodiments, the control signal may control, e.g., lights, switches, etc. in the ambient to adjust the ambient state. For example, the image output device 130 may output a control signal to adjust the color of the light and/or the light intensity, on/off states of an electrical appliance, opening/closing of a curtain, or the like. In some embodiments, the image output device 130 may include a movable mechanical device. The movable mechanical device may perform one or more operations responding to a control signal outputted by the image output device 130, to facilitate the interaction between the user and an avatar. In some embodiments, the image output device 130 may be fixed. In some embodiments, the image output device 130 may be mounted on a movable mechanism to achieve relatively great interaction spaces.

The content output device 140 may be used to output content(s) relating to interaction between the system 100 and the user. The content(s) may be a voice content, a text content, or the like, or a combination thereof. In some embodiments, the content output device 140 may be a speaker or any device that includes a speaker. The interaction content may be outputted in the form of voice. In some embodiments, the content output device 140 may include a display. The interaction content may be displayed on the display in the form of text.

The server 150 may be a single server or a server group. Each server in the server group may be connected through a wired or wireless network. The server group may be centralized, for example, a data center. The server group may be distributed, e.g., a distributed system. The server 150 may be used to collect the information transmitted by the input device 120, analyze and process the inputted information based on the database 160, generate the output content, and convert the output content into an image and/or an audio/text signal to the image output device 130 and/or the content output device 140. As shown in FIG. 1-A, the database 160 may be separate and connected to the network 170. One or more components of the system 100 (e.g., the server 150,) may access the database 160 via the network 170.

The database 160 may store information for semantic analysis and voice interaction. The database 160 may store information of a user (e.g., identity information, historical usage information, etc.) who uses the system 100. The database 160 may also store auxiliary information relating to the interaction between the system 100 and the user, including information of a specific character, information of a specific place, information of a specific scene, or the like. The database 160 may also include a language library including information of different language.

The network 170 may be a single network or a combination of networks. For example, the network 170 may include a local area network (LAN), a wide area network (WAN), a public network, a private network, a proprietary network, a public switched telephone network (PSTN), an Internet, a wireless network, a virtual network, or the like, or any combination thereof. The network 170 may include multiple network access points such as a router/switch 170-1 and a base station 170-2, etc., through which one or more components of the system 100 may be connected to the network 170 to exchange data and/or information.

The network 170 may be any type of wired or wireless network, or a combination thereof. The wired network may include a fiber optic, a cable, or the like. The wireless network may include a Bluetooth, a wireless local area network (WLAN), a Wi-Fi, a WiMax, a near field communication (NFC), a ZigBee, mobile networks (2G, 3G, 4G, 5G networks, etc.), or the like, or any combination thereof.

FIG. 1-B is a schematic diagram illustrating an exemplary HMI system according to some embodiments of the present disclosure. FIG. 1-B is similar to FIG. 1-A. In FIG. 1-B, the database 160 may be a part of the server 150 and be directly connected to the server 150. The connection or communication of the database 160 and the server 150 may be implemented via a wired or wireless network. In some embodiments, other components of the system 100 (e.g., the input device 120, the image output device 130, the content output device 140, etc.) or a user may access the database 160 via the server 150.

In FIG. 1-A or FIG. 1-B, different components of the system 100 and/or the user may have different access permissions to the database 160. For example, the server 150 may have the highest access permission to the database 160, and can read or modify information from the database 160. As another example, one or more components of the system (e.g., the input device 120, the image output device 130, the content output device 140, etc.) can only read partial information when certain conditions are met. As a further example, the user can only read personal information of himself/herself and other related information. Different users may have different access permissions to the database 160.

In order to implement different modules, units, and the functions of them described in the present disclosure, the computer hardware platform may be used as a hardware platform for the one or more elements described above. Since these hardware elements, operating systems and program languages are common, it may be assumed that persons skilled in the art may be familiar with these techniques and may be able to provide information required in the HMI according to the techniques described herein. A computer with user interface may be used as a personal computer (PC), or other types of work stations or terminal devices. After being properly programmed, a computer with user interface may be used as a server. It may be considered that those skilled in the art may also be familiar with such structures, programs, or general operations of this type of computer device. Thus, no extra explanations are needed for all drawings.

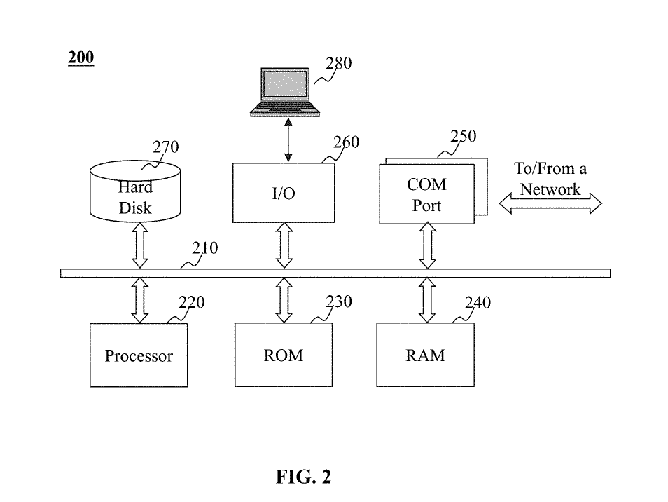

FIG. 2 is a schematic diagram illustrating an exemplary computing device according to some embodiments of the present disclosure. The computing device 200 may be used to implement a special system disclosed in the present disclosure. In some embodiments, the input device 120, the image output device 130, the content output device 140, the server 150, and the database 160 described in FIG. 1 may include one or more of the computing device 200 described in FIG. 2. Exemplary computing devices may include a personal computer, a laptop computer, a tablet computer, a mobile phone, a personal digital assistant (PDA), smart glasses, a smart watch, a smart ring, a smart helmet, or any other smart portable devices or wearable devices, or the like, or any combination thereof. The computing device 200 may be a general purpose computer or a special purpose computer, both may be configured to implement the special system (e.g., the HMI system 100) in the present disclosure. The computing device 200 may be configured to implement any component of the HMI system 100 as described herein. For example, the server 150 may be implemented on the computing device 200, via its hardware devices, software programs, firmware, or any combinations thereof. For brevity, FIG. 2 depicts only one computer. In some embodiments, the computer functions relating to the HMI as described herein may be implemented in a distributed fashion on a group of similar platforms, to disperse the processing load.

The computing device 200 may include a communication (COM) port 250 connected to and from a network connected thereto to implement the data communication. The computing device 200 may also include a processor 220, in the form of one or more processors, for executing program instructions. The computing device 200 may include an internal communication bus 210, different types of program storage units and data storage units, e.g., a hard disk 270, a read-only memory (ROM) 230, a random-access memory (RAM) 240), for various data files to be processed and/or transmitted by the computer, and some program instructions executed by the processor 220. The computing device 200 may also include an I/O component 260 that may support the input and output of data flows between the computer and other components therein (e.g., a user interface 280). The computing device 200 may also send and receive information and data from the network 170 via the COM port 250.

Various aspects of methods of providing information required by HMI and/or methods of implementing other steps by programs are described above. The programs of the technique may be considered as “products” or “artifacts” presented in the form of executable codes and/or relative data. The programs of the technique may be joined or implemented by computer-readable media. Tangible and non-volatile storage media may include any type of memory or storage that is applied in computer, processor, similar devices, or relative modules. For example, a variety of semiconductor memories, tape drives, disk drives, or similar devices that may provide storage function for software at any time.

Some or all of the software may sometimes communicate via a network, e.g., Internet or other communication networks. This kind of communication may load software from a computer or a processor to another. For example, software may be loaded from a management server or a main computer of the HMI system 100 to a hardware platform in a computer environment, or to other computer environments capable of implementing the HMI system 100, or to systems with similar functions of providing information required by HMI. Correspondingly, another medium used to transmit software elements may be used as a physical connection among some of the equipment. For example, an optical wave, an electric wave, an electromagnetic wave, etc. may be transmitted by an optical cable, a cable, or air. Media used to carry waves, e.g., a cable, wireless connection, an optical cable, or the like, may also be considered as media of hosting software. Herein, unless the tangible “storage” media are particularly designated, other terminologies representing the “readable media” of a computer or a machine may represent media joined by the processor when executing any instruction.

A computer-readable medium may be in various forms, including but not limited to, a visible storage medium, a carrier medium, a physical transmission medium, or the like. Exemplary stable storage media may include a compact disc, a magnetic disk, or storage devices that are applied in other computers or similar devices and capable of achieving all components of the system described in the drawings. Exemplary unstable storage media may include a dynamic memory, e.g., a main memory of the computer platform. Exemplary tangible transmission media may include a coaxial cable, a copper cable and optical fiber, including circuits forming the internal communication bus of the computing device 200. The carrier medium may transmit electric signals, electromagnetic signals, sound signals, optical wave signals, etc. These signals may be generated by radio frequency or infrared data communication. General computer-readable media may include a hard disk, a floppy disk, a magnetic tape, or any other magnetic media; a CD-ROM, a DVD, a DVD-ROM, or any other optical media; a punched card, or any other physical storage media including aperture mode; a RAM, a PROM, an EPROM, a FLASH-EPROM, or any other memory chip or magnetic tape; a carrier used to transmit data or instructions, a cable or a connection device used to transmit the carrier, or any other program code and/or data accessible to a computer. A portion of the computer-readable media described above may be applied in executing instructions or transmitting one or more results by the processor.

The term “module,” as used herein, refers to logic embodied in hardware or firmware, or a set of software instructions. The “module” described herein may be implemented as software and/or hardware, or may be stored in any type of non-transitory computer-readable medium or other storage devices. In some embodiments, a software module may be compiled and linked into an executable program. The software module herein can be callable from itself or from other modules, and/or may be invoked in response to detected events or interrupts. The software module configured for execution on a computing device (e.g., the processor 220) may be provided on a computer-readable medium, such as an optical disc, a digital optical disc, a flash drive, a magnetic disk, or any other tangible medium, or as a digital download (and can be originally stored in a compressed or installable format that needs installation, decompression, or decryption prior to execution). Such software code may be stored, partially or fully, on a storage device of the computing device, for execution by the computing device. The software instructions may be embedded in firmware, such as an erasable programmable read only memory (EPROM). It will be further appreciated that hardware modules may be included in connected logic components, such as gates and flip-flops, and/or can be included in programmable units, such as programmable gate arrays or processors. The functions of the modules or computing devices described herein may be preferably implemented as software modules, but may also be represented in hardware or firmware. In general, the module described herein refers to a logic module that may be combined with other modules or divided into sub-modules despite their physical organization or storage.

FIG. 3 is a schematic diagram illustrating a holographic image generation device according to some embodiments of the present disclosure. The holographic image generation device 300 may include a frame 310, an imaging component 320, and a projection component 330. The frame 310 may accommodate the imaging component 320. In some embodiments, the shape of the frame 310 may include a cube, a sphere, a pyramid, or any other geometric shape. In some embodiments, the frame 310 may be totally enclosed. In some embodiments, the frame 310 may be non-enclosed. The imaging component 320 may be coated with a holographic film. In some embodiments, the imaging component 320 may be made of a transparent material, e.g., glass, an acrylic plate, or the like. As shown in FIG. 3, the imaging component 320 may be placed in the frame 310 at an angle of, e.g., 45 degrees to the horizontal plane. In some embodiments, the imaging component 320 may be a touch screen. The projection component 330 may include a projection device such as a projector. The image projected by the projection component 330 is reflected by imaging component 320 coated with the holographic film to generate a holographic image. The projection component 330 may be mounted on the above or below of the frame 310.

FIG. 4 is a schematic diagram illustrating a holographic image generation device according to some embodiments of the present disclosure. The holographic image generation device 400 may include a projection component 420 and an imaging component 410. The imaging component 410 may display a holographic image. In some embodiments, the imaging component 410 may be made of glass. In some embodiments, the imaging component 410 may be a touch screen. In some embodiments, the imaging component 410 may be coated with a mirror film and a holographic image film. The projection component 420 may project on the reverse side of the imaging component 410. When the user is on the front side of the imaging component 410, the holographic image projected by the projection component 420 and the mirror image reflected by the imaging component 410 may be observed at the same time.

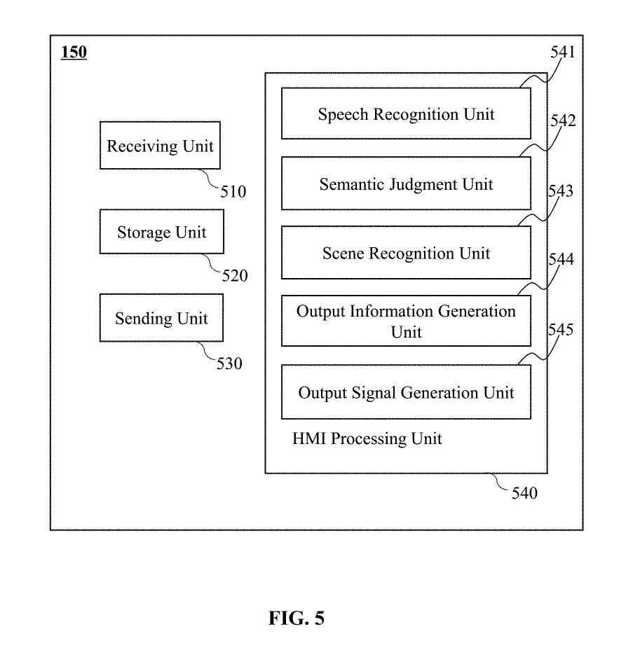

FIG. 5 is a schematic diagram illustrating an exemplary server 150 according to some embodiments of the present disclosure. The server 150 may include a receiving unit 510, a storage unit 520, a sending unit 530, and a human-machine interaction (HMI) processing unit 540. The units in the server 150 may be connected to or communicate with each other via a wired connection or a wireless connection. The receiving unit 510 and the sending unit 530 may implement the functions of the I/O component 260 described in FIG. 2, supporting the input/output of data flows between the HMI processing unit 540 and other components in the system 100 (such as the input device 120, the image output device 130, and the content output device 140). The storage unit 520 may implement the functions of the program storage unit and/or data storage unit described in FIG. 2, e.g., the hard disk 270, the ROM 230, the RAM 240, for various data files to be processed and/or transmitted by the computer, and some program instructions executed by the processor 220. The HMI processing unit 540 may implement the functions of the processor 220 described in FIG. 2. In some embodiments, the HMI processing unit 540 may include one or more processors.

The receiving unit 510 may receive information and data from the network 170. The sending unit 530 may send the data generated by the HMI processing unit 540 and/or the information and data stored in the storage unit 520 via the network 170. The received information (e.g., user information) may be stored in the receiving unit 510, the storage unit 220, the database 160, or any storage device that may be integrated into or independent of the system 100.

The storage unit 520 may store information received by the receiving unit 510, which may be further processed by the HMI processing unit 540. The storage unit 520 may also store intermediate data and/or information generated by the HMI processing unit 540 during the processing. The storage unit 520 may be or include any storage device such as a hard disk, a solid-state storage device, an optical disc, etc. In some embodiments, the storage unit 520 may also store additional data or information used by the HMI processing unit 540. For example, the storage unit 520 may store formulas or rules used by the HMI processing unit 540 when performing calculations, or store criteria or thresholds used by the HMI processing unit 540 when making a judgment, or the like.

The HMI processing unit 540 may be configured to process the information received or stored by the server 150. For example, the HMI processing unit 540 may perform calculations on the information, make a judgment on the information, or the like. The information may include image information, voice information, text information, or other signal information, or the like. The information may be obtained by one or more input devices or sensors, such as a keyboard, a tablet, a button, a mouse, a camera, a video camera, an infrared sensor, a somatosensory sensor, a brain wave sensor, a speed sensor, an accelerometer, a positioning devices (e.g., a global positioning system (GPS), a global navigation satellite system (GLONASS), a Beidou navigation system, a Galileo positioning system (Galileo), a quasi-zenith satellite system (QAZZ), a base station positioning system, a Wi-Fi positioning system, etc.), a pressure sensor, a light sensor, a temperature sensor, a humidity sensor, etc. The image information may include a photo or video relating to a user and an application scene. The voice information may include information provided by voice input from the user collected by the input device 120. The signal information may include an electrical signal, a magnetic signal, an optical signal, e.g., including an infrared signal collected by an infrared sensor, an electrical signal generated by a somatosensory sensor, a brain wave signal collected by a brain wave sensor, an optical signal collected by a light sensor, a speed signal collected by a speed sensor, etc. The information processed by the HMI processing unit 540 may also include temperature information collected by a temperature sensor, humidity information collected by a humidity sensor, a geographic location collected by a positioning device, a pressure signal collected by a pressure sensor, etc. The text information may include text information inputted by the user via the keyboard or the mouse of the input device 120, or text information received from the database. The HMI processing unit 540 may include different types of processors, for example, an image processor, an audio processor, a signal processor, a text processor, and the like.

The HMI processing unit 540 may be used to generate output information and signals according to the signals and information inputted by the input device 120. The HMI processing unit 540 may include a speech recognition unit 541, a semantic judgment unit 542, a scene recognition unit 543, an output information generation unit 544, and an output signal generation unit 545. The information that the HMI processing unit 540 receives, generates, and sends during the processing may be stored in the receiving unit 510, the storage unit 520, the database 160, or any storage device that may be integrated into or independent of the system 100.

In some embodiments, the HMI processing unit 540 may include, but is not limited to, a central processing unit (CPU), an application specific integrated circuit (ASIC), an application specific instruction set processor (ASIP), a physics processing unit (PPC), a digital processing processor (DSP), a field-programmable gate array (FPGA), a programmable logic device (PLD), a processor, a microprocessor, a controller, a microcontroller, or the like, or any combination thereof.

The speech recognition unit 541 may convert a speech signal from the user collected by the input device 120 into a text, an instruction, or other information. In some embodiments, the speech recognition unit 541 may use a speech recognition model to analyze and extract the speech signal. In some embodiments, the speech recognition model may include a statistical acoustic model, a machine learning model, etc. In some embodiments, the speech recognition model may include a vector quantization (VQ), a hidden Markov model (HMM), an artificial neural network (ANN), and a deep neural network (DNN), etc. In some embodiments, the speech recognition model may be a pre-trained speech recognition model. The pre-trained speech recognition model may implement different speech recognition effects according to vocabularies used by the user, a speed of speech, ambient noise, etc. in different scenes. In some embodiments, the speech recognition unit 541 may select, among a plurality of pre-trained speech recognition model for different scenes, a pre-trained speech recognition model according to a scene determined by the scene recognition unit 543. For example, the scene recognition unit 543 may determine the scene based on the voice signal, the electrical signal, the magnetic signal, the optical signal, the infrared signal, the brain wave signal, the optical signal, the speed signal, etc. collected by the input device 120. For example, if the scene recognition unit 543 recognizes that the user is in an outdoor environment, the speech recognition unit 541 may select a pre-trained speech recognition model for noise reduction to process the speech signal.

The semantic judgment unit 542 may determine user intention information based on the user input. The user input may include the text or the instruction converted by the speech recognition unit 541, or a text or an instruction inputted by the user in a text manner, or the like, or any combination thereof. The semantic judgment unit 542 may determine the user intention information included in the voice input by analyzing the character and syntax in the text. In some embodiments, the semantic judgment unit 542 may determine the user intention information included in the user input by analyzing the context of the user input. In some embodiments, the context of the user input may include contents of one or more user inputs received by the system 100 before the current user input. In some embodiments, the semantic judgment unit 542 may determine the user intention information based on user input(s) and/or scene information before the current user input. The semantic judgment unit 542 may perform functions such as word segmentation, part of speech (POS) analysis, grammar analysis, entity recognition, anaphora resolution, semantic analysis, or the like.

In the present disclosure, the word segmentation may refer to a process of dividing words in the text. In some embodiments, exemplary word segmentation algorithms may include a mechanical word segmentation algorithm based on a combination of lexicon and statistics, a character matching-based word segmentation algorithm (e.g., a forward maximum matching algorithm, a reverse maximum matching algorithm, a two-way maximum matching algorithm, a shortest route algorithm), a machine learning-based word segmentation algorithm.

In the present disclosure, the POS analysis may refer to a process of classifying words according to their grammatical characteristics. In some embodiments, exemplary POS analysis algorithms may include a rule-based POS analysis algorithm, a statistical model-based POS analysis algorithm, a machine learning-based POS analysis algorithm, a deep learning-based POS analysis algorithm (e.g., a Hidden Markov model (HMM) algorithm, a conditional random fields algorithm)

In the present disclosure, the grammar analysis may refer to a process of generating grammatical structures of the text according to defined grammars based on the POS analysis. In some embodiments, exemplary grammar analysis algorithms may include a rule-based grammar analysis algorithm, a statistical model-based grammar analysis algorithm, a machine learning-based grammar analysis algorithm (e.g., a deep neural network, an artificial neural network, a maximum entropy, a support vector machine (SVM), etc.).

In the present disclosure, the semantic analysis may refer to a process of converting the text into an expression that the computer can understand. In some embodiments, exemplary semantic analysis algorithms may include a machine learning algorithm. The entity recognition may refer to a process of identifying namable vocabularies in the text and classifying and naming the namable vocabularies using the computer. The entity may include a name of a person, a name of a place, an organization, time, etc. For example, vocabularies in a sentence may be named and classified according to the name of the person, the organization, a location, time, quantity, etc. In some embodiments, the entity recognition algorithm may include a machine learning algorithm.

In the present disclosure, the anaphora resolution may refer to a process of searching an antecedent corresponding to a pronoun in the text. For example, in the sentence “Mr. Zhang came over and showed everyone his new creation.” the pronoun is “his” and the antecedent of the pronoun is “Mr. Zhang.” In some embodiments, the anaphora resolution algorithm may include a centering theory-based anaphora resolution algorithm, a filtering principle-based anaphora resolution algorithm, an optimization principle-based anaphora resolution algorithm, a machine learning-based anaphora resolution algorithm ((e.g., a deep neural network, an artificial neural network, a regression algorithm, a maximum entropy, a support vector machine (SVM), a clustering algorithm, etc.).

In some embodiments, the semantic judgment unit 542 may include an intention classifier. For example, if the user input is “How's the weather today?”, the semantic judgment unit 542 may recognize that the sentence includes entities “Today,” “Weather,” and further recognize that the user may have an intention of inquiring weather according to the time based on this sentence or a pre-trained speech recognition model. If the user input is “How's the weather in Beijing today?”, the semantic judgment unit 542 may recognize that the sentence includes entities “Today,” “Weather,” “Beijing,” and further recognize that the user may have an intention of inquiring weather according to the location and the time based on this sentence or a pre-trained speech recognition model.

The scene recognition unit 543 may perform a scene recognition using the input information collected by the input device 120 to obtain a target scene in which the user uses the HMI system 100. In some embodiments, the scene recognition unit 543 may determine the target scene based on the information inputted by the user. In some embodiments, the user may enter a name of a target scene into the system 100 via a text input device (e.g., a keyboard, a tablet, etc.). In some embodiments, the user may select a target scene via a non-text input device (e.g., a mouse, a button, etc.). In some embodiments, the scene recognition unit 543 may determine the target scene that the HMI system 100 applies by collecting the information provided by voice input. In some embodiments, the scene recognition unit 543 may determine the target scene based on information regarding a geographic location of the user. The scene recognition unit 543 may determine the target scene that the HMI system 100 applies based on the user intention information generated by the semantic judgment unit 542. In some embodiments, the scene recognition unit 543 may determine the target scene that the HMI system 100 applies based on the input information collected by the input device 120. For example, the scene recognition unit 543 may determine the target scene based on the image signal captured by the camera/video camera, the infrared signal collected by the infrared sensor, movement information collected by the somatosensory sensor, the brain wave signal collected by the brain wave sensor, the speed signal collected by the speed sensor, the acceleration signal collected by the accelerometer, the location information collected by the positioning device (e.g., the global positioning System (GPS), the Global Navigation Satellite System (GLONASS), the Beidou navigation system, the Galileo positioning system (Galileo), the Quasi-Zenith Satellite System (QAZZ), the base station positioning system, the Wi-Fi positioning system, etc.), the pressure information collected by the pressure sensor, the light signal collected by the light sensor, the temperature information collected by the temperature sensor, the humidity information collected by the humidity sensor, or the like. In some embodiments, the scene recognition unit 543 may determine the target scene by matching the user intention information with information of specific scenes stored in the database 160.

The output information generation unit 544 may generate output information based on the semantic analysis result generated by the semantic judgment unit 542 and the image information, the text information, information regarding the geographic location, the scene information, and other information received by the input device 120. In some embodiments, the output information generation unit 544 may determine the output information by searching for information from a system database (e.g., the database 160) based on the semantic analysis result generated by the semantic judgment unit 542. In some embodiments, the output information generation unit 544 may determine the output information by invoking a third party service application based on the semantic analysis result generated by the semantic judgment unit 542. In some embodiments, the output information generation unit 544 may determine the output information by performing a search through the Internet based on the semantic analysis result generated by the semantic judgment unit 542.

In some embodiments, the output information may include information relating to an avatar. In some embodiments, the avatar may include a cartoon character, an anthropomorphic animal character, a real historical character, a real contemporary character, or the like, or any combination thereof. In some embodiments, the output information may include information used to assist the voice information, such as a movement of the avatar, a lip movement of the avatar, expression of the avatar, or the like. In some embodiments, the output information may include language and semantic information expressed by the avatar. In some embodiments, the output information may include information related to a verbal expression, a tone, a voiceprint information, etc. of the language represented by the avatar that can generate a voice signal. In some embodiments, the output information may include scene control information. In some embodiments, the scene control information may include information relating to a light control, a motor control, and/or a switch control.

The output information generation unit 544 may generate the output information based on the user intention information generated by the semantic judgment unit 542. In some embodiments, the output information generation unit 544 may determine the output information by invoking a service application based on the user intention information. In some embodiments, the output information generation unit 544 may determine the output information by searching for information from a system database (e.g., the database 160) based on the user intention information. In some embodiments, the output information generation unit 544 may determine the output information by performing a search through the Internet based on the user intention information by invoking an application capable of connected the Internet. In some embodiments, the output information generation unit 544 may determine the output information by processing the user intention information based on a big data analysis. For instance, a user intention model may be generated based on the big data analysis. The user intention model may provide a mapping relationship between user intention information and the corresponding output information. In some embodiments, the user intention model may be updated periodically or from time to time. In some embodiments, the user intention model may be updated locally by the user, or updated automatically according to a defaulting setting of the system 100, or updated by a service provider that provides the HMI services. In some embodiments, the user intention model may be updated based on data and/or information from the user (e.g., previous interaction information between the user and the system 100), or from one or more other users that interact with the system 100, or data from a third party that includes a relationship between user intention information and its corresponding output information. The output information generation unit 544 may analyze the user intention information according to the user intention models to determine the output information. For example, when the user intention information is “Asking for the definition of water,” the output information generation unit 544 may obtain relevant information by searching for information from a knowledge library (such as a natural science knowledge library) based on the semantic analysis result (i.e., the user intention information). As another example, when the user input information is “Writing a Mid-Autumn Festival poem,” the semantic judgment unit 542 may determine that the intention of the user is inquiring a poem according to a theme. The output information generation unit 544 may find poems with the “Mid-Autumn Festival” theme and return a query result based on the user intention information.

The output signal generation unit 545 may be configured to generate an output signal (e.g., an image signal, a speech signal, and other signals) based on the output information. In some embodiments, the output signal generation unit 545 may include a digital/analog conversion circuit. In some embodiments, the image signal may include a holographic image signal, a three-dimensional image signal, a virtual reality (VR) image signal, an augmented reality (AR) image signal, a mixed reality (MR) image signal, or the like. The other signals may include a control signal, e.g., including an electrical signal, a magnetic signal, or the like. In some embodiments, the output signal may include a speech signal and a visual signal of the avatar. In some embodiments, the speech signal and the visual signal may be matched according to a machine learning algorithm. In some embodiments, the machine learning algorithm may include a hidden Markov model, a deep neural network model, or the like. In some embodiments, the visual signal of the avatar may include a lip movement of the avatar, a gesture of the avatar, an expression of the avatar, a body shape of the avatar (e.g., forward tilt, back tilt, upright, sideways, etc.), a motion of the avatar (e.g., a speed of walking, stride, direction, nod, shake head, etc.). The speech signal of the avatar may match with one or more of the lip movement, the gesture, the expression, the body shape, the motion, etc. of the avatar. The matching relationship may be a default setting of the HMI system 100, or specified by the user, or acquired according to the machine-learning algorithm, etc.

It should be understood that the server 150 illustrated in FIG. 5 may be implemented in a variety of approaches. For example, the server 150 may be implemented via hardware, software, or a combination thereof. The hardware may be implemented as specialized logic. The software may be stored in a storage device and may be executed by an appropriate instruction execution system (e.g., a microprocessor, specialized hardware, etc.). It will be appreciated by those skilled in the art that the above system may be implemented as computer-executable instructions and/or embedded in control codes of a processor. For example, the control codes may be provided by a medium such as a disk, a CD or a DVD-ROM, a programmable storage device such as a read-only memory (e.g., firmware), or a data carrier such as an optical or electric signal carrier. A part or all of the HMI system 100 (e.g., the server 150) and modules described herein may not only be implemented by large scale integrated circuits or gate arrays, semiconductor devices (e.g., logic chips, transistors, hardware circuits of programmable hardware devices such as field programmable gate arrays, programmable logic devices, etc.) but may also be implemented by software executed in various types of processors, or a combination of the above hardware circuits and software (e.g., firmware).

It should be noted that the above description of the server 150 is provided for illustration purposes, and is not intended to limit the present disclosure within the scope of the disclosed embodiments. For persons having ordinary skills in the art, various variations and modifications may be conducted under the teaching of the present disclosure. However, those variations and modifications may not depart the spirit and scope of this disclosure. For example, in some embodiments, the server 150 may include the storage unit 520. The storage unit 520 may be an internal unit or an external unit. The storage unit 520 may be included in the server 150, or implement the corresponding function (e.g., storage functions) via a cloud-computing platform. For persons having ordinary skills in the art, units may be combined in various ways, or connect with other units or modules as a sub-system under the teaching of the principle of the server 150 and the human-machine interaction system 100. However, those variations and modifications may not depart the spirit and scope of this disclosure. For example, in some embodiments, the receiving unit 510, the sending unit 530, the HMI processing unit 540, and the storage unit 520 may be different units embodied in one system, or functions of two or more modules may be implemented by one module. For example, the receiving unit 510 and the sending unit 530 may be combined into a module having functions of input and output. As another example, the HMI processing unit 540 and the storage unit 520 may be combined into a single module configured to perform data processing and storing. For example, the units may share one storage unit, or each unit may have a corresponding storage unit. All such modifications are within the protection scope of the present disclosure.

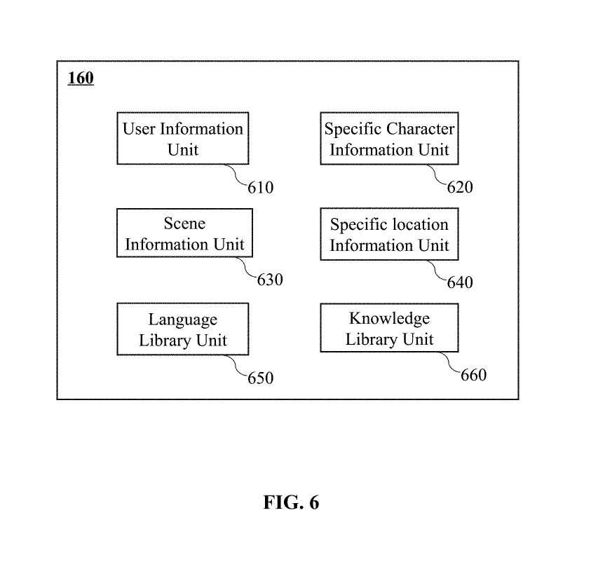

FIG. 6 is a schematic diagram illustrating an exemplary database according to some embodiments of the present disclosure. The database 160 may include a user information unit 610, a specific character information unit 620, a scene information unit 630, a specific location information unit 640, a language library unit 650, and one or more knowledge library unit 660. The data in the database 160 may be stored as structured data or unstructured data. The structured data may be stored in a structured query language (SQL), a not only structured query language (NoSQL), or the like. In some embodiments, the NoSQL may include a graph database, a document store, a key-value store, a column store, or the like. The data in the graph database may be directly correlated using the data structure of a graph. The graph may include nodes, edges, and attributes. The nodes may be connected by edges to form a graph. In some embodiments, the data may be represented by nodes. The relationship between nodes may be represented by edges. Thus, the data in the graph database may be directly correlated. The data in the database 160 may be raw data, or extracted (or processed) data.

The user information unit 610 may store personal information of a user. In some embodiments, the personal information of the user may be stored in the form of a personal profile. The personal profile may include basic information of the user, such as name, gender, age, or the like, or any combination thereof. In some embodiments, the personal information of the user may be stored in the form of a personal knowledge map. The personal knowledge map may include dynamic information of the user, such as hobbies, emotions, etc., of the user. In some embodiments, the personal information of the user may include a name, a gender, an age, a nationality, an occupation, a position, an education background, a school, a hobby, a specialty, etc., of the user. In some embodiments, the personal information of the user may also include biological information of the user, such as a facial feature, a fingerprint, a voiceprint, DNA, a retinal feature, an iris feature, a venous distribution, etc., of the user. In some embodiments, the personal information of the user may also include behavioral information of the user, such as a handwriting feature, a gait feature, etc., of the user. In some embodiments, the personal information of the user may include account information of the user. The account information of the user may include login information in the system 100, such as a login name, a password, a security key, etc., of the user. The personal information of the user may include information pre-stored in the database, information inputted into the system 100 by the user directly, or information extracted based on the interaction information between the user and the system 100. For example, when a user interacts with the system 100 via voice input, if contents related to a work location of the user occurs, an answer from the user to a question may be identified and stored in the user information unit 610. In some embodiments, the personal information of the user may include historical information relating to the interaction between the user and the system 100. The historical information may include voice of the user, intonation of the user, voiceprint information of the user, conversation content, or the like. In some embodiments, the historical information may include time, a place, etc. when the user interacts with the system 100. When interacting with the user, the system 100 may match the information received by the input device 120 with personal information of multiple users stored by the user information unit 610 to identify an identity of the user. In some embodiments, the system 100 may identify the identity of the user according to the login information inputted by the user. In some embodiments, the system 100 may identify the identity of the user based on the biological information of the user, such as the facial feature, the fingerprint, the voiceprint, DNA, the retina feature, the iris feature, the venous distribution, or the like. In some embodiments, system 100 may identify the identity of the user based on the behavioral information of the user, such as the handwriting feature, the gait feature, etc. In some embodiments, the system 100 may identify the emotional feature of the user by analyzing the interaction information between the user and the system 100 based on the user information unit 610, and may adjust the output information based on the emotional feature of the user. For example, the system 100 may determine the emotional feature of the user by recognizing the expression or intonation of the user. In some embodiments, the system 100 may determine that the emotional feature of the user is pleasant according to the content and intonation of the voice input, and the system 100 may output a cheerful music.

The specific character information unit 620 may store information relating to a specific character. In some embodiments, the specific character may be a real or fictional individual character, or a real or fictional group character. For example, the specific character may include a real historical character, a leader of a country, an artist, an athlete, a fictional character derived from works of art, etc. In some embodiments, information relating to the specific character may include identity information, creation information, voice information, experience information, personality information of the specific character, a historical background and a historical environment that the specific character lives, or the like. In some embodiments, the information relating to the specific character may be derived from real historical data. In some embodiments, the information relating to the specific character may be determined by processing data. In some embodiments, the information relating to the specific character may be determined by analyzing and extracting third-party review information. In some embodiments, the historical background and the historical environment that the specific character lives may be determined according to a feature of the corresponding history/environment. In some embodiments, the information relating to the specific character stored in the specific character information unit 620 may be static, and the information relating to the specific character may be pre-stored in the system 100. In some embodiments, the information relating to the specific character stored in the specific character information unit 620 may be dynamic, and the system 100 may change or update the information relating to the specific character according to the information collected by the input device 120 (such as the voice input).

When the user communicates with an avatar of a historical character through the system 100, the system 100 may adjust the output information based on the historical background, language feature associated with the historical character stored in the specific character information unit 620. For example, the avatar may resemble the poet Li Bai. When the user and the avatar of Li Bai talks about the weather the same day, the system 100 may output correct weather information the same day. When the system 100 states the weather information through the avatar, the avatar of Li Bai may use a language of the Tang Dynasty when providing weather information. In some embodiments, the information stored in the specific character information unit 620 may be related to the identity, the experience, etc., of a specific avatar. For example, the specific character information unit 620 may set an avatar resembling Li Bai who does not speak a foreign language. When the user speaks a foreign language to Li Bai, the answer may be “I don't understand.”

In some embodiments, the identity information of the specific character may be the name, the gender, the age, the occupation, etc., of the specific character. In some embodiments, the creation information of the specific character may be a poem, a song, a painting, etc., created by the specific character. In some embodiments, the voice information of the specific character may be an accent, a tone, a language, etc., of the specific character. In some embodiments, the experience information of the specific character may be a historical event that the specific character has experienced. The historical event may include an academic experience, an award-winning experience, a work experience, a medical experience, a family status, a relationship with relatives, a circle of friends, a travel experience, a shopping experience, etc. For example, the specific character information unit 620 stores a historical event that athlete Liu Xiang participated in the 2004 Athens Olympic Games and won a championship. When the user talks with an avatar of Liu Xiang about the 2004 Athens Olympic Games, the avatar of Liu Xiang may introduce information relating to the Olympic Games to the user from the perspective of a participant.

The scene information unit 630 may be used to store information related to application scenes of the system 100. In some embodiments, the application scenes of the system 100 may be specific scenes, such as an exhibition hall, a tourist attraction, a classroom, a home, a game scene, a shopping mall, or the like.

In some embodiments, the information relating to the exhibition hall may include guide information of the exhibition hall, including location information of the exhibition hall, map information of the exhibition hall, exhibit information, service time information, or the like.

In some embodiments, the information relating to the tourist attraction may include tour information of the tourist attraction, including map information of the tourist attraction, round-trip traffic information, and introduction information of the tourist attraction.

In some embodiments, the information relating to a classroom may include course information, including an explanation for a textbook, an answer to a question, or the like.

In some embodiments, the information relating to the home may include home service information, including control of a household device, or the like. In some embodiments, the household device may include a refrigerator, an air conditioner, a television, an electric light, a microwave oven, an electric fan, an electric blanket, or the like.

In some embodiments, the information relating to the game scene may include game rule information, including the number of participants, action rules, winning and losing judgment rules, scoring rules, or the like.

In some embodiments, the information relating to the shopping mall may include shopping guide information, including category information of commodities, inventory information, introduction information, price information, or the like.

The specific location information unit 640 may store geographic location-based information. In some embodiments, the geographic location-based information may include route information relating to a particular location, navigation information to a point of interest (POI), or the like. In some embodiments, the geographic location-based information may include information regarding points of interest (POS) near the particular location, such as restaurants, hotels, shopping malls, hospitals, schools, banks, or the like.

The language library unit 650 may store information of different languages. In some embodiments, the language library unit 650 may store a plurality of languages, such as Chinese, English, French, Japanese, German, Russian, Italian, Spanish, Portuguese, Arabic, or the like. In some embodiments, the language information stored by the language library unit 650 may include linguistic information, such as semantics, grammar, or the like. In some embodiments, the language information may include translation information between different languages.

The knowledge library unit 660 may store knowledge in different fields. The knowledge library unit 660 may include knowledge of entities and their attributes, knowledge of relationships between entities, knowledge of events, behaviors, states, knowledge of causal relationships, knowledge of process sequences, or the like. In some embodiments, the knowledge library may be represented by a knowledge map. The knowledge map may a knowledge map that includes information of a specific domain (such as a music knowledge map), or a knowledge map that includes information of general domains (such as a general knowledge map). In some embodiments, in the knowledge library unit 660, multiple definitions for the same kind of information may be matched with different avatars to generate different output results. The definitions herein may include popular definitions and professional definitions, special meanings of specific vocabularies in different eras, or the like. For example, there may be two definitions for “Buddha” in the knowledge library unit 660. One is the definition of a Buddhist by a professional religious person, and the other is a popular definition that the general public can understand. As another example, in the knowledge library unit 660, the system 100 may give different output results when the identities of the avatars are different. For example, the user asks the system 100 “What is water,” if the identity of the avatar is an ordinary person, the output result generated by the system 100 may be “Water is a colorless and odorless liquid.” If the identity of the avatar is a chemistry teacher, the output result generated by the system 100 may be “Water is an inorganic substance composed of two elements of hydrogen and oxygen.”

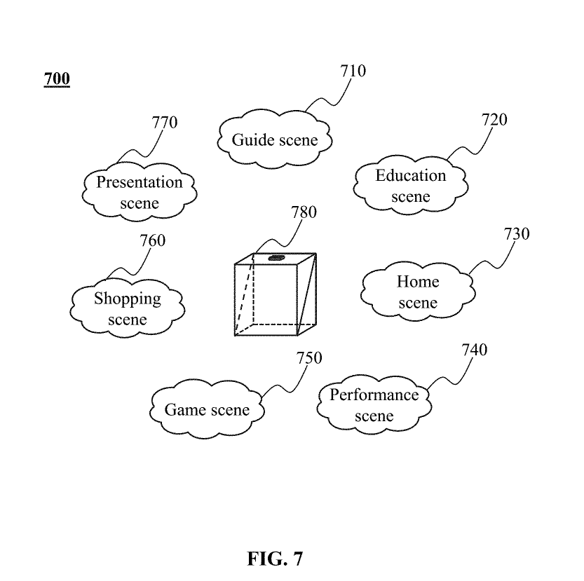

FIG. 7 is a schematic diagram 700 illustrating exemplary application scenes of the HMI system 100 according to some embodiments of the present application; As shown in FIG. 7, the HMI system 100 may be applied to a guide scene 710, an education scene 720, a home scene 730, a performance scene 740, a game scene 750, a shopping scene 760, a presentation scene 770, or the like. In some embodiments, the system 100 may generate output information based on the input information inputted by the user. The output information may include an image signal. The image signal may be displayed as a holographic image or in another manner. In some embodiments, the holographic image may be generated by the holographic image generation device 780. The holographic image generation device 780 may have the same or substantially same components as the holographic image generation device 300. The input information may be inputted into the system 100 by the user actively, for example, voice input, manual input, or the like. The input information may also be collected by, for example, sensors, cameras, positioning devices (e.g., a global positioning system (GPS), a global navigation satellite system (GLONASS), a Beidou navigation system, a Galileo positioning system (Galileo), a quasi-zenith satellite system (QAZZ), a base station positioning device, a Wi-Fi positioning device, or the like. The image signal may include an avatar that is capable of interacting with the user. The avatar may be a virtual image that can speak, act, and express its feelings. In some embodiments, speech, lip movement, motion, and expression of the avatar may be coordinated by the control of the system 100.

In some embodiments, the avatar may be a real or fictional individual character, or a real or fictional group character. The avatar may be a cartoon character with anthropomorphic expressions and motions, a fictional character with specific identity information, an animal character, a real character with specific identity information, and so on. The avatar may have human features such as gender, skin color, race, age, faith, or the like. The avatar may have animal features (such as race, age, body type, coat color, etc.), or features of fictional characters created by a user (such as a cartoon character, etc.). In some embodiments, the user may select a character stored in the system 100 as the avatar. In some embodiments, the user may create an avatar manually. The created avatar may be stored in the system 100 for selection by the user in the future. In some embodiments, the creation of avatar may be obtained by modifying, adding, and/or reducing some features of an existing virtual image. In some embodiments, the user may create a virtual image based on the resources provided by the system 100. In some embodiments, the user may provide some information to the system 100. A virtual image may be created by the user actively or by the system 100. For example, the user may provide some information to system 100, such as his own photo or data of his body feature to create an image as the avatar of himself. In some embodiments, the user may freely select, purchase, or rent an avatar provided by a third party other than the system 100. In addition, in conjunction with resources from internal of the system 100, external storages, Internet, or databases, the avatar may provide the user with services that include multiple information. The information may include audio information, video information, image information, text information, or the like, or any combination thereof. In some embodiments, after the user selects an avatar, the system 100 may determine the output information based on the information about the avatar stored in a database. In some embodiments, after the user selects an avatar, the output information may be selected by the user. For example, when the user selects an avatar of a teacher stored in the system 100, the system 100 may generate output information based on the feature information of the teacher. For example, when the user asks for a grammar question, the avatar may give a corresponding answer. As another example, after user A selects an avatar of a teacher stored in the system 100, the output information of the avatar may be determined by the user. If User B communicates with the avatar of the teacher, the output information may be determined by other information entered by User A. For example, the output information of the avatar may copy the voice information and expression information of User A (or any other person).

According to some embodiments of the present disclosure, the HMI system 100 may be applied to the guide scene 710. For example, when the system 100 determines that the user needs the HMI system 100 to provide a guide service based on the input information, such as information provided by voice input or scene information, the system 100 may output an image signal (e.g., a holographic image). The holographic image may include an avatar, for example, an avatar of a guide, or the like. In some embodiments, the user may provide information to the system 100 to create an image that the user likes. In some embodiments, the avatar may provide users with guide services in conjunction with resources from the internal of the system 11, external storages, Internet, or database. The avatar of the guide may provide users with information relating to the geographic location of the user to guide the user. The avatar of the guide may provide the user with relevant information, such as restaurants, hotels, attractions, convenience stores, public transportation stations, gas stations, traffic conditions, etc.

According to some embodiments of the present disclosure, the HMI system 100 may be applied to the education scene 720. For example, when the system 100 determines that the user intention information is to receive training based on input information, such as information provided by the voice input, or the scene information, etc., the system 100 may output an image signal. The image signal may include an avatar. For example, when a user needs to learn a language through the HMI system 100, the avatar may be a well-known foreign language teacher or an avatar of a foreigner. For example, when a user needs a cosmological discussion through the HMI system 100, the avatar may be the famous physicist Hawking, a physics professor, or any avatar chosen by the user. In some embodiments, the user may provide information to the system 100 to create an avatar that the user likes. For example, the user may provide the system 100 with a photo or body features that he/she prefers to select as an avatar, to create an avatar manually or by the system 100. In some embodiments, the avatar may provide users with education services in conjunction with resources from the internal of the system 100, an external storage device, Internet, or a database.

According to some embodiments of the present disclosure, the HMI system 100 may be applied to the home scene 730. In some implementations, the system 100 may interact with the user to mimic human motion and sound. In some embodiments, the system 100 may realize the control of smart home through a wireless network. For example, the system 100 may adjust the temperature of a smart conditioner according to instructions by voice input of the user. In some embodiments, in conjunction with resources from the internal of the system 100, an external storage, Internet, or a database, the system 100 may provide users with multimedia resources like music, video, TV show, etc.

According to some embodiments of the present disclosure, the HMI system 100 may be applied to the performance scene 740. In some embodiments, the system 100 may provide an avatar as a presenter of performance for the user. In some embodiments, the user may communicate with the avatar of the presenter, and the avatar of the presenter may introduce the background of the performance, the content of the performance, profiles of actors, or the like. In some embodiments, the system 100 may use a holographic projection character instead of a real character to perform on the stage, so that the effect of the performance may also be presented in the case that the actor is absent. In some embodiments, the system 100 may display the holographic projection character during the performance of the actor to generate interactive performance effects of virtual and real characters.

According to some embodiments of the present disclosure, the HMI system 100 may be applied to the game scene 750. In some embodiments, the system 100 may provide a video game for the user, such as a bowling game, a sports game, a virtual online game, or the like. The user's operation for the video game may be implemented by means of voice, gestures, and/or movement of the body. In some embodiments, the system 100 may generate an avatar that interacts with the user in the video game, and the user may interact with the avatar during the video game to increase the entertainment of the video game.

According to some embodiments of the present disclosure, the HMI system 100 may be applied to the shopping scene 760. In some embodiments, the HMI system 100 may be applied to a wireless supermarket shopping system. A display screen may display the corresponding contents and holographic stereo images of products for the user to select. In some embodiments, the system 100 may be applied to an entity shopping scene. A display screen may display specific locations of products in the supermarket for the user to quickly locate. In some embodiments, the system 100 may also provide individual recommendations for the user. For example, when purchasing clothing, the system 100 may generate a virtual stereoscopic image, providing the user with a three-dimensional image of the cloth when it is worn.

According to some embodiments of the present disclosure, the HMI system 100 may be applied to the presentation scene 770. In some embodiments, the system 100 may provide an avatar of an object that needs to be explained to facilitate the instructor. In some embodiments, the instructor may be a real character, or an avatar. For example, the system 100 may generate an avatar of a human body to help to introduce the structure of the human body. The system 100 may further provide detailed human anatomy based on the avatar of the human body. In some embodiments, a portion of the avatar of the human body being introduced may be highlighted. For example, all or part of a blood circulation system of the avatar of the human body may be highlighted for ease of introduction or display. In some embodiments, the system 100 may provide an avatar of an instructor to provide a tutorial service for the user. For example, during a trip, the avatar of the instructor of the system 100 may explain to the user history, a geographic location of the tourist attraction, travel considerations, etc.

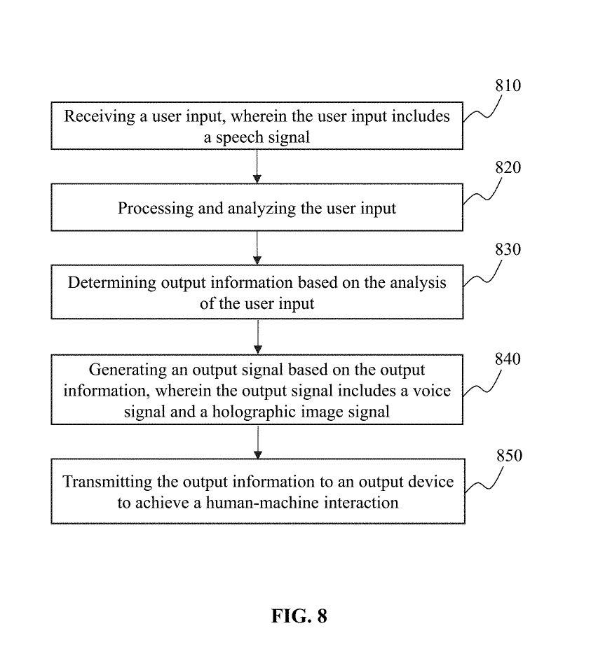

FIG. 8 is a flowchart of an exemplary process for human-machine interaction according to some embodiments of the present disclosure. As shown in FIG. 8, in 810, the system 100 may receive a user input. The operation may be implemented by the input device 120. The user input may include a speech signal. The speech signal may include voice data of the environment that the user locates. The speech signal may include identity information of a user, user intention information, and other background information. For example, when the user asks the system 100 “What is the Buddha,” the speech signal may include the identity information of the user, such as voiceprint information. The speech signal may also include the user intention information; for example, the user wants the system 100 to answer the definition of the Buddha. The speech signal may also include other background information, such as the ambient noise when the user inputs voice into the system 100. In some embodiments, the speech signal may include feature information of the user, for example, the voiceprint information, user intention information, or the like. The user intention information may include address, weather conditions, traffic conditions, network resources, or other information, or the like, or any combination thereof. The input information may be provided or entered by the user actively, or detected by a terminal detection device of the user. The terminal detection device may include a sensor, a camera, an infrared sensor, a positioning device (e.g., a global positioning system (GPS), a global navigation satellite system (GLONASS), a Beidou navigation system, a Galileo positioning system (Galileo), a quasi-zenith satellite system (QAZZ), a base station positioning device, a Wi-Fi positioning device, etc.), or the like, or any combination thereof. In some embodiments, the terminal detection device may be a smart device equipped with a detection program or software such as a smartphone, a tablet computer, a smart watch, a smart bracelet, smart glasses, or the like, or any combination thereof.

In 820, the system 100 may process and analyze the user input. The operation may be implemented by the server 150. The processing of the user input may include compressing, filtering, noise reduction, or the like, or any combination thereof. For example, after receiving the speech signal, the server 150 may reduce or remove noise in the speech signal, such as ambient noise, system noise, etc., and extract voice of the user within the speech signal. Based on the semantic analysis and voiceprint extraction of the speech signal of the user, the system 100 may extract a voice feature of the user, and obtain user intention information and identity information. In some embodiments, the processing of the user input may also include a process of converting the speech signal. For example, the system 100 may convert the speech signal into a digital signal. In some embodiments, the signal conversion may be implemented by an analog to digital conversion circuit. The analysis on the user input may include analyzing the identity information, physiological information, psychological information, etc. of the user based on the user input. In some embodiments, the analysis on the user input may also include an analysis on scene information that the user locates. For example, based on the user input, the system 100 may analyze the geographic location of the user, scene information that the user locates, etc. For example, by analyzing the speech signal and the scene information, the system 100 may extract a voice feature of the user. By comparing the extracted voice feature with data in the database, the system 100 may obtain the identity information of the user and the user intention information. For example, if the user sends a speech signal “open the door” to the system 100 at the home entrance, the system 100 may extract the voice feature (e.g., the voiceprint information) by analyzing the speech signal. The system 100 may compare the extracted voice feature with the data in the database to determine the identity of the user, for example, the family member. The system 100 may then obtain the user intentional information (e.g., open the door) based on the geographic location of the user (e.g., home entrance).

In 830, the system 100 may determine the output information based on the analysis of the user input. The operation may be implemented by the server 150. The output information of the system 100 may include conversation content, voice, motion, background music, background light signal, or the like, or any combination thereof. The voice may include language, tone, pitch, loudness, tone, or the like, or any combination thereof. The background light signal may include frequency information of the light, intensity information of the light, duration information of the light, blinking frequency of the light, or the like, or any combination thereof. In some embodiments, based on the analysis result of the user input, the system 100 may determine the user intention information. The system 100 may determine the output information based on the user intention information. In some embodiments, the matching between the user intention information and the output information may be determined by real-time analysis. For example, the system 100 may obtain the user intention information by analyzing the information provided by the voice input, perform a search and calculation based on sources of the database according to the user intention information, and determine the output information. In some embodiments, the matching between the user intention information and the output information of the system 100 may be determined based on the matching relationship stored in the database.

In some embodiments, if the user has sent an instruction to the system 100 during a historical use, for example, “Making a poem in a style of Li Bai,” the system 100 may determine that the output information is a poem A in the style of Li Bai. When the user sends an instruction “Making a poem in the style of Li Bai” to system 100, the system 100 may directly find a matching relationship of the corresponding instruction stored in the database and the poem A in the style of Li Bai based on the instruction, and determine that the output information is poem A in the style of Li Bai, sparing the search and calculation process.

The system 100 may determine a content of interaction between the avatar and the user through the identity, motion, emotion, etc. of the user. The expression, motion, character, voice, tone, and speaking style of the avatar generated by the system 100 may vary in accordance with the content of HMI. For example, after determining the identity of the user via face recognition, the system 100 may actively communicate with the user by calling the name of the user. In some embodiments, the system 100 (e.g., the scene recognition unit 543 of the system 100) may identify the user activity near the system 100 via an infrared sensor. For example, a user may approach the system 100, or the user may walk around the system 100. In some embodiments, the system 100 may actively initiate the system 100 and interact with the user when detecting that a user is approaching. In some embodiments, the system 100 may change the shape of the avatar according to the detected direction of the user activity, for example, adjusting the direction that the avatar faces based on the movement of the user so that the avatar maintains a face-to-face posture with the user. In some embodiments, the system 100 may determine an application scene based on the emotional feature of the user. The system 100 may determine the emotional feature by face recognition or by analyzing a speech speed, a tone of the speech signal. The emotions of the user may be happy, shy, and angry. In some embodiments, the system 100 may determine the output information based on the emotional feature. For example, if the emotion of the user is happy, the system 100 may control the avatar to show a happy expression (such as a big laugh). If the emotion of the user is shy, the system 100 may control the avatar to show a shy expression (such as blush). If the emotion of the user is angry, the system 100 may control the avatar to show an angry expression, or the system 100 may control the avatar to show a comforting expression and/or say comfort words to the user.

In 840, the system 100 may generate an output signal based on the output information. The operation may be implemented by the server 150. The output signal may include a voice signal, an image signal (such as a holographic image signal, etc.). The feature of the voice signal may include language, tone, pitch, loudness, timbre, or the like, or any combination thereof. In some embodiments, the voice signal may further include a background signal that creates a specific scene atmosphere, such as a background music signal, a background noise signal, or the like. The feature of the image signal may include an image size, an image content, a position of the image, a duration of the image, or the like, or any combination thereof. In some embodiments, the generation of the output signal based on the output information may be implemented by a CPU. In some embodiments, the generation of the output signal based on the output information may be implemented by the analog/digital conversion circuit.

In 850, the system 100 may transmit the output information to the image output device 130 and the content output device 140 to achieve the human-machine interaction. The operation may be implemented by the server 150. The image output device 130 may include a projection device, an artificial intelligence device, a projection lamp device, a display device, or the like, or any combination thereof. The projection device may be a holographic projection device. The display device may include a television, a computer, a smartphone, a smart bracelet, and/or smart glasses. In some embodiments, the image output device 130 may also include a smart home device including a refrigerator, an air conditioner, a television, an electric lamp, a microwave oven, an electric fan, an electric blanket, or the like. The output information may be transmitted to the image output device 130 via a wired or wireless connection, or a combination thereof. The wired connection may include a coaxial cable, a twisted pair, an optical fiber, or the like. The wireless connection may include a Bluetooth, a WLAN, a Wi-Fi, and/or a ZigBee. The content output device 140 may be a speaker or any other device that includes a speaker. The content output device 140 may also include a graphic or text output device, or the like.

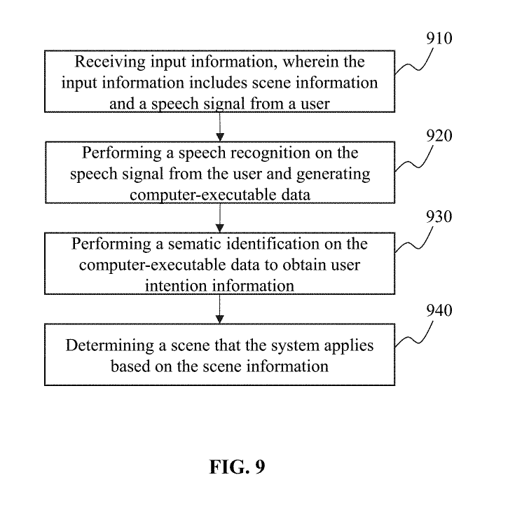

FIG. 9 is a flowchart of an exemplary process for semantic extraction according to some embodiments of the present disclosure. As shown in FIG. 9, in 910, the system 100 may receive input information. The operation may be implemented by the input device 120. The input information may include scene information and/or a user input (including a speech signal, also referred to as a voice input) from the user. The input information may be inputted by typing via a keyboard or a button, voice input, or the like. In some embodiments, the input information may be collected by other device that can collect user information, such as a sensor, a camera, an infrared sensor, a positioning device (a global positioning system (GPS), a global navigation satellite system (GLONASS), a Beidou navigation system, a Galileo positioning system (Galileo), a quasi-zenith satellite system (QAZZ), a base station positioning device, a Wi-Fi positioning device, or the like, or any combination thereof. The scene information may include information regarding a geographic location of the user and/or an application scene. The geographic location of the user may be a geographic location or location information of the user. The scene information may include scene change data during the interaction. In some embodiments, the information regarding the geographic location of the user and/or the application scene may be automatic detected by a smart terminal device, or provided or modified by the user. In some embodiments, the system 100 may obtain the scene information using the signal collected by the input device 120.

In 920, the system 100 may convert the speech signal to computer-executable data. The operation may be implemented by the speech recognition unit 541. In some embodiments, the conversion to the speech signal may also include the processing of the speech signal. The processing of the speech signal may include compressing, filtering, and noise reduction, or the like, or any combination thereof. In some embodiments, the system 100 may identify the information in the speech signal (or the voice input) by a voice recognition device or program, and convert the recognized information in the speech signal into computer-executable text information. In some embodiments, the speech signal may be converted into a digitized speech signal, and the digitized speech signal may be encoded to convert the speech signal into the computer-executable data. The speech signal may be converted to a digitized speech signal via an analog/digital conversion circuit. In some embodiments, the speech signal may be analyzed to obtain voice feature information of the user, such as voiceprint information of the user. In some embodiments, in 920, the system 100 may identify other input signals and convert them into computer-executable data, such as electrical signals, optical signals, magnetic signals, image signals, pressure signals, or the like.

In 930, the system 100 may perform a semantic identification on the computer-executable data. In 930, the system 100 may extract information from the computer-executable data by performing a word segmentation, a part of speech (POS) analysis, a grammar analysis, an entity recognition, an anaphora resolution, a semantic analysis, etc. to generate user intention information. The operation may be implemented by the semantic judgment unit 542. For example, if the user input is “How's the weather today?”, the system 100 (e.g., the semantic judgment unit 542) may recognize that the sentence includes entities “Today,” “Weather,” and recognize that the user may have an intention of inquiring weather according to time based on this sentence or a pre-trained speech recognition model. In some embodiments, the user intention information may include feature information of the user, for example, identity information, mental condition information, physical condition information, or the like. In some embodiments, the system 100 (e.g., the semantic judgment unit 542 in the system 100) may generate the user intention information according to the user input. The user input may be a text or an instruction determined by processing the voice input by the system 100 (e.g., the speech recognition unit 541), or a text or an instruction inputted by the user in a text manner, or a text or an instruction determined according to information inputted by the user in other manners. The system 100 (e.g., the semantic judgment unit 542 in the system 100) may identify sentence information and entity information included in the user input. For example, if the user input is “What is Buddha?”, the system 100 (for example, the semantic judgment unit 542 in the system 100) may determine that the sentence is used to inquire a definition, and determine the question including the entity “Buddha”. If the user input is “Write a poem with the theme of separation”, the system 100 (e.g., the semantic judgment unit 542 in the system 100) may identify entities “poem”, “separation” included in the sentence, and may determine that the sentence is used to search for a poem based on the theme. In some embodiments, the system 100 may generate the user intention information based on the user input and information in database 160. A detailed description of the intention judgment or semantic judgment may be found elsewhere in the present disclosure (e.g., referring to the description of the HMI processing unit 540 in FIG. 5). The data in the database 160 may include identity information of the user, security verification information of the user, history operation information of the user, or the like, or any combination thereof. In some embodiments, based on the data in the database and the scene information, the system 100 may generate the user intention information to predict the operation of the user. For example, by confirming that the user may do the same operation (such as turning on the air conditioner in the home) at a certain geographic location (the company) during a certain duration (between 17:00 and 18:00 after work) in a recent time period (three months), the system 100 may identify that the user may have an intention to turn on the air conditioner in the home when he/she is in the company between 17:00 and 18:00. Based on this speculation, the system 100 may actively ask the user if it is necessary to turn on the air conditioner in the home and make a corresponding control operation according to the user's answer.

In 940, the system 100 may determine a scene that the system 100 applies based on the scene information. The operation may be implemented by the scene recognition unit 543. In some embodiments, the system 100 (e.g., the scene recognition unit 543) may determine a target scene directly based on the information in the user input. In some embodiments, the user may enter a name of the target scene into the system 100 via a text input device (e.g., a keyboard, a tablet, etc.). In some embodiments, the user may select a target scene among a plurality of scenes through a non-text input device (such as a mouse, a button, etc.). In some embodiments, the system 100 (e.g., the scene recognition unit 543 in the system 100) may determine the target scene by analyzing the user intention information. In some embodiments, the system 100 (e.g., the scene recognition unit 543 in the system 100) may identify the target scene by matching the user intention information with the information of specific scenes stored in the database 160. In some embodiments, the system 100 (e.g., the scene recognition unit 543 in the system 100) may perform a scene recognition according to information obtained by other input devices. For example, the system 100 may determine the scene information by an image capturing device. In some embodiments, the system 100 (e.g., the scene recognition unit 543 in the system 100) may perform an image recognition (e.g., face recognition) on an image captured by an image capturing device (such as a camera, a video camera). In some embodiments, the system 100 (e.g., the scene recognition unit 543 in the system 100) may determine the identity of the user that uses the system 100 by face recognition, and determine a target scene corresponding to the identity of the user. In some embodiments, the system 100 (e.g., the scene recognition unit 543 in the system 100) may determine whether a person is approaching around the system 100 by an infrared sensor.

It should be understood that the process of semantic extraction illustrated in FIG. 9 is only provided for the purposes of illustration, and is not intended to limit the scope of the present disclosure. For persons having ordinary skills in the art, multiple variations and modifications may be made under the teachings of the present disclosure. However, those variations and modifications do not depart from the scope of the present disclosure. For example, the operation 940 may not be limited to be performed after operations 910, 920, 930 are completed. In some embodiments, the operation 940 may be implemented between operations 910 and 920. In some embodiments, the operation 940 may be implemented between operations 920 and 930.

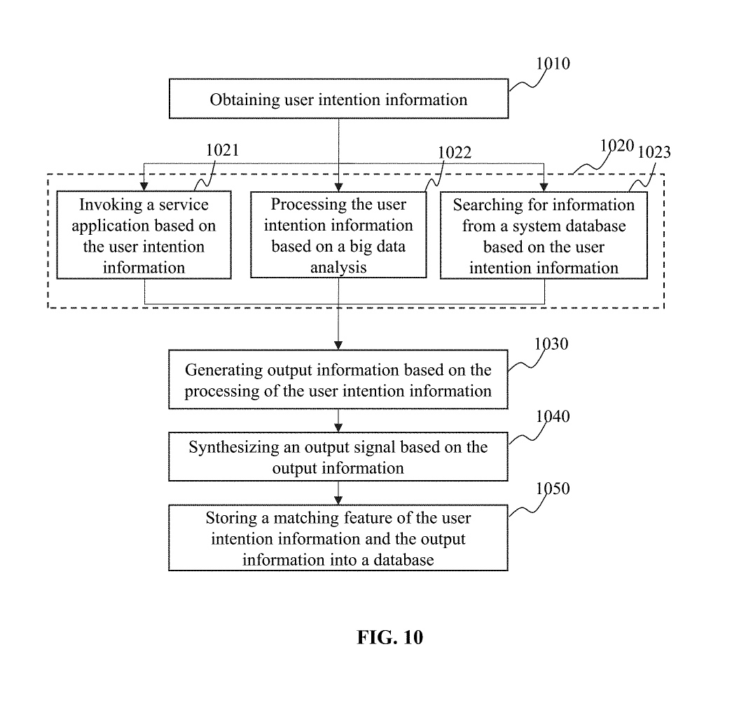

FIG. 10 is a flowchart illustrating an exemplary process for determining an output signal according to some embodiments of the present disclosure. As shown in FIG. 10, in 1010, the system 100 may obtain user intention information. The process of obtaining the user intention information has been explained in detail in FIG. 9, and the descriptions thereof are not repeated herein.

In 1020, the system 100 may analyze the user intention information to generate a processing result relating to the user intention information. The operation may be implemented by the output information generation unit 544. The operation 1020 may be implemented according to one or more exemplary ways. For example, in 1021, the system 100 may invoke a service application based on the user intention information. In 1022, the system 100 may process the user intention information based on a big data analysis. In 1023, the system 100 may search for information from a system database based on the user intention information. In some embodiments, the system 100 (e.g., the output information generation unit 544) may perform a search through the Internet based on the user intention information by invoking an application capable of connecting to the Internet. In some embodiments, the system 100 (e.g., the output information generation unit 544 in the system 100) may obtain flight information, weather information by invoking a service application. In some embodiments, the system 100 (e.g., the output information generation unit 544 in the system 100) may obtain a calculation result by invoking a calculator. In some embodiments, the system 100 (e.g., the output information generation unit 544 in the system 100) may inform the user of a schedule by invoking a calendar. In some embodiments, the system 100 may directly generate a control instruction according to the user intention information. For example, when the system 100 is used in a smart home system, when the user gives an instruction “turn on the air conditioner” to the system 100, the speech recognition unit 541 and the semantic judgment unit 542 may analyze the intention of the user. Based on the intention of the user, the output information generation unit 544 may generate an instruction to turn on the air conditioner.

In 1030, the system 100 may generate output information based on the processing of the user intention information. In some embodiments, the information representing the intention of the user may be obtained in operation 1020. In 1030, the system 100 may determine the information as the output information. In some embodiments, if the information representing the intention of the user cannot be obtained in operation 1020, the processing of the user intention information may determine a failure result. In 1030, the system 100 may determine the failure result as the output information. For example, if an avatar is the ancient Chinese poet Li Bai, the output information may be “I'm sorry, I don't know.” when the user talks with the avatar of Li Bai in English. In some embodiments, if the user does not provide sufficient information to generate the user intention information, the system 100 (e.g., the output information generation unit 544 in the system 100) may generate a question asking the user to provide more information. For example, if the user asks “How is the weather today?” and does not provide the location information, and the location device in the system 100 does not successfully obtain the location information, the system 100 (e.g., the output information generation unit 544 in the system 100) may generate a question “Which city do you want to know about the weather?”. The output information may include conversation content, voice information, motion information, background music information, background light information, or the like, or any combination thereof. The voice content may include language, tone, pitch, loudness, tone, or the like, or any combination thereof. The background light information may include frequency information of the light, intensity information of the light, duration information of the light, blinking frequency information of the light, or the like, or any combination thereof.

In 1040, the system 100 may synthesize an output signal based on the output information. The operation may be implemented by the output signal generation unit 545. The output signal may include a speech signal, an optical signal, an electrical signal, or the like, or any combination thereof. The optical signal may include an image signal, such as a 3D holographic projection image, or the like. The image signal may also include a video signal. In some embodiments, the output signal may be generated based on the output information by the HMI unit 540 and/or the analog/digital conversion circuit.

In 1050, the system 100 may store a matching feature of the user intention information and the output information into, e.g., the receiving unit 510, the storage unit 520, the database 160, or any storage device integrated into or independent of the system 100. In some embodiments, the user intention information may be extracted by analyzing the user input. The matching feature of the user intention information and output information may be stored in the database. In some embodiments, the matching feature data stored in the database may be base data for subsequent feature comparison of user intention information and/or user input. In a future application scene, the system 100 may compare the matching feature data and the user intention information and/or the user input to generate output information based on the comparison result. In some embodiments, the comparison result may be a series of comparison values. When a comparison value triggers a comparison threshold, the comparison may be successful. The system 100 may generate output information based on the comparison result and the matching feature data in the database.

The basic concepts have been described above, and it is obvious that the above detailed disclosure is merely exemplary for those skilled in the art and does not constitute a limitation on the present application. Although not explicitly illustrated herein, those skilled in the art may make various modifications, improvements, and corrections to the present application. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various parts of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present application may be performed entirely by hardware, may be performed entirely by software (including firmware, resident software, microcode, etc.), or may be performed by a combination of hardware and software. Each of the above hardware or software may be described as “data block”, “module”, “engine”, “unit”, “component”, or “system”. Furthermore, aspects of the present disclosure may take the form of a computer program product embodied in one or more computer-readable media having computer readable program code embodied thereon.

A computer readable signal medium may include a propagated data signal with computer readable program code embodied therein, for example, in baseband or as part of a carrier wave. The propagated signal may have a variety of manifestations, including electromagnetic forms, optical forms, etc., or suitable combinations of them. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python, or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scene, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure method does not mean that the features required by the subject of the application are more than those mentioned in the claims. Rather, claim subject matter lie in less than all features of a single foregoing disclosed embodiment.

In some embodiments, the numbers expressing quantities of ingredients, properties, and so forth, used to describe and claim certain embodiments of the application are to be understood as being modified in some instances by the term “about,” “approximate,” or “substantially”. Unless otherwise stated, “about,” “approximate,” or “substantially” may indicate ±20% variation of the value it describes. Accordingly, in some embodiments, the numerical parameters set forth in the description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each patent, patent application, patent application publication and other materials cited herein, such as articles, books, instructions, publications, documents, articles, etc., are hereby incorporated by reference in their entirety. Application history documents that are inconsistent or conflicting with the contents of the present application are excluded, and documents (currently or later attached to the present application) that limit the widest range of the scope of the present application are also excluded. It is to be noted that if the description, definition, and/or terminology used in the appended application of the present application is inconsistent or conflicting with the contents described in this application, the description, definition and/or terminology may be subject to the present application.

At last, it should be understood that the embodiments described in the present application are merely illustrative of the principles of the embodiments of the present application. Other modifications that may be employed may be within the scope of the application. Thus, by way of example, but not of limitation, alternative configurations of the embodiments of the application may be utilized in accordance with the teachings herein. Accordingly, embodiments of the present application are not limited to the embodiments that are expressly introduced and described herein.

We claim:

1. A method for human-machine interaction, comprising:
receiving input information, wherein the input information includes scene information and a user input from a user;
determining an avatar based on the scene information;
determining user intention information based on the user input; and
determining output information based on the user intention information, wherein the output information includes interaction information between the avatar and the user.

2. The method of claim 1, further comprising: presenting the avatar based on the output information.

3. The method of claim 1, wherein the user input includes information provided by voice input.

4. The method of claim 3, wherein the determining user intention information based on the user input comprises:
extracting entity information and sentence information included in the voice input; and
determining the user intention information based on the entity information and the sentence information.

5. The method of claim 1, wherein the determining an avatar comprises:
generating a visual presentation of the avatar by a holographic projection.

6. The method of claim 1, wherein the interaction information between the avatar and the user comprises a motion and a verbal communication by the avatar.

7. The method of claim 6, wherein the motion of the avatar comprises a lip movement of the avatar that matches the verbal communication by the avatar.

8. The method of claim 1, wherein the output information is determined based on the user intention information and specific information of the avatar.

9. The method of claim 8, wherein the specific information of the avatar includes at least one of identity information, creation information, voice information, experience information, or personality information of a specific character that the avatar represents.

10. The method of claim 1, wherein the scene information regarding a geographic location of the user.

11. The method of claim 1, wherein the determining output information based on the user intention information comprises at least one of:
searching for information from a system database,
invoking a third party service application, or
processing the user intention information based on a big data analysis.

12. The method of claim 1, wherein the avatar comprises a cartoon character, an anthropomorphic animal character, a real historical character, or a real contemporary character.

13. A system for human-machine interaction, comprising:
a processor configured to execute one or more executable modules stored in a computer-readable storage medium;
the computer-readable storage medium storing a set of instructions, wherein when executed by the processor, the set of instructions cause the processor to perform operations including:
receiving input information, wherein the input information includes scene information and a user input from a user;
determining an avatar based on the scene information;
determining user intention information based on the user input; and
determining output information based on the user intention information, wherein the output information includes interaction information between the avatar and the user.

14. The system of claim 13, wherein the set of instructions cause the processor to perform additional operations including: presenting the avatar based on the output information.

15. The system of claim 13, wherein the user input includes information provided by voice input.

16. The system of claim 15, wherein the determining user intention information based on the user input comprises:
extracting entity information and sentence information included in the voice input; and
determining the user intention information based on the entity information and the sentence information.

17. The system of claim 13, wherein the determining an avatar comprises:
generating a visual presentation of the avatar by a holographic projection.

18. The system of claim 13, wherein the interaction information between the avatar and the user comprises a motion and a verbal communication by the avatar.

19. The system of claim 18, wherein the motion of the avatar comprises a lip movement of the avatar that matches the verbal communication by the avatar.

20. A non-transitory computer-readable medium for executing a human-machine interaction, storing information, wherein when a computer reads the information, the computer performs operations comprising:
receiving input information, wherein the input information includes scene information and a user input from a user;
determining an avatar based on the scene information;
determining user intention information based on the user input; and
determining output information based on the user intention information, wherein the output information includes interaction information between the avatar and the user.
